(19) United States
(12) Patent Application Publication
(10) Pub. No.: US 2020/0073913 A1
(43) Pub. Date: Mar. 5, 2020

(54) METHOD AND APPARATUS FOR PROCESSING DATA SEQUENCE

(71) Applicant: Baidu Online Network Technology (Beijing) Co., Ltd., Beijing (CN)

(72) Inventors: Qian DOU, Beijing (CN); Qingrui SUN, Beijing (CN); Junfei ZHANG, Beijing (CN); Chen YANG, Beijing (CN)

(21) Appl. No.: 16/508,981

(22) Filed: Jul. 11, 2019

(30) Foreign Application Priority Data
Aug. 29, 2018 (CN) 201810992992.9

(51) Int. Cl. G06F 17/16; G06F 7/78; G06F 7/60

(52) U.S. Cl. CPC G06F 17/16; G06F 7/60; G06F 7/78

(57) ABSTRACT

Some embodiments of the present disclosure relate to a method and apparatus for processing a data sequence. An implementation of the method includes: generating a Hankel matrix based on a to-be-processed data sequence, the to-be-processed data sequence including zigzag noise; performing singular value decomposition on the Hankel matrix to obtain a left singular matrix, a singular value vector, and a right singular matrix, components of each dimension of the singular value vector being ordered from large to small; determining a noise component in each component of the singular value vector; zeroing each dimension of noise component in the singular value vector; generating a reconstructed Hankel matrix based on the left singular matrix, the singular value vector after zeroing, and the right singular matrix; and generating a processed data sequence based on the reconstructed Hankel matrix.

### CROSS-REFERENCE TO RELATED APPLICATIONS

This application claims priority to Chinese Application No. 201810992992.9, filed on Aug. 29, 2018 and entitled “Method and Apparatus for Processing Data Sequence,” the entire disclosure of which is hereby incorporated by reference.

### TECHNICAL FIELD

Embodiments of the present disclosure relate to the field of computer technology, specifically to a method and apparatus for processing a data sequence.

### BACKGROUND

A data sequence is a sequence including at least one data arranged in chronological order. The data herein is mostly a numerical value that represents a state indicator. For example, the data herein may be state indicator data acquired by a sensor in an autonomous vehicle. In practice, an acquired data sequence often has noise, and it is necessary to remove the noise to effectively use the data sequence. At present, denoising of the data sequence mostly requires a priori assumption of the data distribution of the acquired data source. For example, it is assumed that the Gaussian distribution is met, but in practice, the data distribution of the acquired data source often does not necessarily meet the assumed prior distribution.

### SUMMARY

Embodiments of the present disclosure relate to methods and apparatuses for processing a data sequence.

In a first aspect, the embodiments of the present disclosure provide a method for processing a data sequence, including: generating a Hankel matrix based on a to-be-processed data sequence, the to-be-processed data sequence including zigzag noise; performing singular value decomposition on the Hankel matrix to obtain a left singular matrix, a singular value vector, and a right singular matrix, components of each dimension of the singular value vector being ordered from large to small; determining a noise component in each component of the singular value vector; zeroing each dimension of noise component in the singular value vector; generating a reconstructed Hankel matrix based on the left singular matrix, the singular value vector after zeroing, and the right singular matrix; and generating a processed data sequence based on the reconstructed Hankel matrix.

In some embodiments, the generating a Hankel matrix based on a to-be-processed data sequence, includes: determining whether the to-be-processed data sequence includes zigzag noise; and generating, in response to determining that the to-be-processed data sequence includes zigzag noise, the Hankel matrix based on the to-be-processed data sequence.

In some embodiments, the to-be-processed data sequence includes N data; and the generating the Hankel matrix based on the to-be-processed data sequence, includes: determining, according to N, a number of rows R and a number of columns C of the Hankel matrix, where a sum of R and C is equal to a sum of N plus 1; and setting the to-be-processed data sequence to be: X=[x₁, x₂, . . . , x_{N}], and calculating to obtain the Hankel matrix H according to the following formula:

H(i,j)=xᵢ₊ⱼ₋₁

Here, i is an integer between 1 and R, and j is an integer between 1 and C.

In some embodiments, the generating a processed data sequence based on the reconstructed Hankel matrix, includes: setting the reconstructed Hankel matrix to be H′, and generating the processed data sequence X′=[x₁′, x₂′ . . . , x_{N}′] based on the reconstructed Hankel matrix H′ according to the following formula:

$${x}_{k}^{′} = \frac{1}{n - m + 1} {\sum }_{j = m}^{n} {H}^{′} ( k - j + 1 , j ) , m = max ( 1 , k - R + 1 ) , n = min ( C , k )$$

Here, k is an integer between 1 and N.

In some embodiments, the determining a noise component in each component of the singular value vector, includes: setting a positive integer w to 1, the singular value vector being E={σ₁, σ₂, . . . , σ_{M}}, where M is a positive integer; performing a following noise component determining operation: calculating a noise suppression ratio ρ_{w} corresponding to a component of a w^{th} dimension of the singular value vector according to the following formula:

$${ρ}_{w} \approx \frac{{\sum }_{i = 1}^{w} {σ}_{i}}{{\sum }_{i = 1}^{M} {σ}_{i}} ;$$

determining, in response to determining that the noise suppression ratio ρ_{w} obtained by calculation is greater than or equal to a preset noise suppression ratio threshold, components between the w^{th} dimension and the M^{th} dimension of the singular value vector as noise components, and ending the noise component determining operation, where the preset noise suppression ratio threshold is a value greater than 0 and less than 1; and updating, in response to determining that the noise suppression ratio ρ_{w} obtained by calculation is not greater than or equal to the preset noise suppression ratio threshold, w to a sum of w plus 1, and continuing performing the noise component determining operation.

In some embodiments, the determining a noise component in each component of the singular value vector, includes: setting the singular value vector to be E={σ₁, σ₂, . . . , σ_{M}}, where M is a positive integer; finding a noise boundary dimension v from the singular value vector, where a noise suppression ratio of a component of a v^{th} dimension among noise suppression ratios of components of all dimensions of the singular value vector obtained by calculation calculated according to the following formula is closest to a preset noise suppression ratio threshold:

$${ρ}_{w} \approx \frac{{\sum }_{i = 1}^{w} {σ}_{i}}{{\sum }_{i = 1}^{M} {σ}_{i}}$$

where, w is an integer between 1 and M; and determining components between the v^{th} dimension and the M^{th} dimension of the singular value vector as noise components.

In a second aspect, the embodiments of the present disclosure provide an apparatus for processing a data sequence, including: a Hankel matrix generation unit, configured to generate a Hankel matrix based on a to-be-processed data sequence, the to-be-processed data sequence including zigzag noise; a singular value decomposition unit, configured to perform singular value decomposition on the Hankel matrix to obtain a left singular matrix, a singular value vector, and a right singular matrix, components of each dimension of the singular value vector being ordered from large to small; a noise component determination unit, configured to determine a noise component in each component of the singular value vector; a noise component zeroing unit, configured to zero each dimension of noise component in the singular value vector; a Hankel matrix reconstruction unit, configured to generate a reconstructed Hankel matrix based on the left singular matrix, the singular value vector after zeroing, and the right singular matrix; and a data sequence generation unit, configured to generate a processed data sequence based on the reconstructed Hankel matrix.

In some embodiments, the Hankel matrix generation unit includes: a zigzag noise determination unit, configured to determine whether the to-be-processed data sequence includes zigzag noise; and a Hankel matrix generation module, configured to generate, in response to determining that the to-be-processed data sequence includes zigzag noise, the Hankel matrix based on the to-be-processed data sequence.

In some embodiments, the to-be-processed data sequence includes N data; and the Hankel matrix generation module is further configured to: determine, according to N, a number of rows Rand a number of columns C of the Hankel matrix, where a sum of R and C is equal to a sum of N plus 1; and set the to-be-processed data sequence to be: X=[x₁, x₂, . . . , x_{N}], and calculate to obtain the Hankel matrix H according to the following formula:

H(i,j)=xᵢ₊ⱼ₋₁

Here, i is an integer between 1 and R, and j is an integer between 1 and C.

In some embodiments, the data sequence generation unit is further configured to: set the reconstructed Hankel matrix to be H′, and generate the processed data sequence X′=[x₁′, x₂′, . . . , x_{N}′] based on the reconstructed Hankel matrix H′ according to the following formula:

$${x}_{k}^{′} = \frac{1}{n - m + 1} {\sum }_{j = m}^{n} {H}^{′} ( k - j + 1 , j ) , m = max ( 1 , k - R + 1 ) , n = min ( C , k )$$

Here, k is an integer between 1 and N.

In some embodiments, the noise component zeroing unit is further configured to: set a positive integer w to 1, the singular value vector being E={σ₁, σ₂, . . . , σ_{M}}, where M is a positive integer; perform a following noise component determining operation: calculating a noise suppression ratio ρ_{w} corresponding to a component of a w^{th} dimension of the singular value vector according to the following formula:

$${ρ}_{w} \approx \frac{{\sum }_{i = 1}^{w} {σ}_{i}}{{\sum }_{i = 1}^{M} {σ}_{i}}$$

determining, in response to determining that the noise suppression ratio ρ_{w} obtained by calculation is greater than or equal to a preset noise suppression ratio threshold, components between the w^{th} dimension and the M^{th} dimension of the singular value vector as noise components, and ending the noise component determining operation, where the preset noise suppression ratio threshold is a value greater than 0 and less than 1; and update, in response to determining that the noise suppression ratio ρ_{w} obtained by calculation is not greater than or equal to the preset noise suppression ratio threshold, w to a sum of w plus 1, and continue performing the noise component determining operation.

In some embodiments, the noise component zeroing unit is further configured to: set the singular value vector to be E={σ₁, σ₂, . . . , σ_{M}}, where M is a positive integer; find a noise boundary dimension v from the singular value vector, where a noise suppression ratio of a component of a v^{th} dimension among noise suppression ratios of components of all dimensions of the singular value vector obtained by calculation calculated according to the following formula is closest to a preset noise suppression ratio threshold:

$${ρ}_{w} \approx \frac{{\sum }_{i = 1}^{w} {σ}_{i}}{{\sum }_{i = 1}^{M} {σ}_{i}} ;$$

where, w is an integer between 1 and M; and determine components between the v^{th} dimension and the M^{th} dimension of the singular value vector as noise components.

In a third aspect, the embodiments of the present disclosure provide an electronic device, including: one or more processors; a storage apparatus, storing one or more programs thereon; and the one or more programs, when executed by the one or more processors, cause the one or more processors to implement the method according to anyone of the implementations in the first aspect.

In a fourth aspect, the embodiments of the present disclosure provide a computer readable storage medium, storing a computer program thereon, the program, when executed by a processor, implements the method according to any one of the implementations in the first aspect.

The method and apparatus for processing a data sequence provided by the embodiments of the present disclosure, generate a Hankel matrix based on a to-be-processed data sequence including zigzag noise, then perform singular value decomposition on the Hankel matrix to obtain a left singular matrix, a singular value vector, and a right singular matrix, components of each dimension of the singular value vector being ordered from large to small, determine a noise component in each component of the singular value vector based on the singular value vector and a preset noise suppression ratio threshold, zero each dimension of noise component in the singular value vector, generate a reconstructed Hankel matrix based on the left singular matrix, the singular value vector after zeroing, and the right singular matrix, and finally generate a processed data sequence based on the reconstructed Hankel matrix. Therefore, a priori assumption is not performed on the data distribution of the acquired data source, but in the case that the to-be-processed data sequence includes zigzag noise, a singular value decomposition method is used to perform denoising processing on the to-be-processed data sequence, thereby reducing the distance between the resulting data sequence after the denoising processing and the to-be-processed data sequence.

### BRIEF DESCRIPTION OF THE DRAWINGS

After reading detailed descriptions of non-limiting embodiments with reference to the following accompanying drawings, other features, objectives and advantages of the present disclosure will become more apparent:

FIG. 1 is a diagram of an exemplary system architecture in which an embodiment of the present disclosure may be implemented;

FIG. 2 is a flowchart of an embodiment of a method for processing a data sequence;

FIG. 3 is a flowchart of an embodiment of a noise component determining operation;

FIGS. 4A-4F are schematic diagrams of generated data sequences corresponding to different noise suppression ratio thresholds and an original to-be-processed data sequence according to some embodiments of the present disclosure;

FIG. 5 is a flowchart of another embodiment of the method for processing a data sequence;

FIG. 6 is a schematic diagram of an embodiment of an apparatus for processing a data sequence; and

FIG. 7 is a schematic structural diagram of a computer system adapted to implement an electronic device of the embodiments of the present disclosure.

### DETAILED DESCRIPTION OF EMBODIMENTS

The present disclosure will be further described below in detail in combination with the accompanying drawings and the embodiments. It may be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

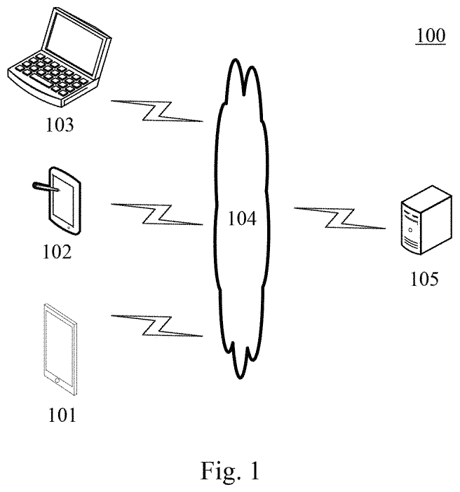

FIG. 1 illustrates an exemplary system architecture 100 in which an embodiment of a method for processing a data sequence or an apparatus for processing a data sequence may be implemented.

As shown in FIG. 1, the system architecture 100 may include terminal devices 101, 102, 103, a network 104, and a server 105. The network 104 serves as a medium providing a communication link between the terminal devices 101, 102, 103 and the server 105. The network 104 may include various types of connections, such as wired or wireless communication links, or optical fibers, or the like.

A user may interact with the server 105 via the network 104 using the terminal devices 101, 102, 103, to receive or transmit messages or the like. Various client applications, such as a data acquisition application, a web browser application, a shopping application, a search application, an instant messaging tool, a mailbox client, or a social platform software, may be installed on the terminal devices 101, 102, and 103.

The terminal devices 101, 102 and 103 may be hardware or software. When the terminal devices 101, 102 and 103 are hardware, the terminal devices may be various electronic devices having display screens, including but not limited to smart phones, tablets, laptop portable computers, desktop computers, etc. When the terminal devices 101, 102 and 103 are software, the terminal devices may be installed in the above-listed electronic devices. the terminal devices may be implemented as a plurality of software or software modules (for example, for providing data acquisition services), or as a single software or software module, which is not specifically limited here.

The server 105 may be a server that provides various services, such as a backend server that supports data acquisition services installed on the terminal devices 101, 102, 103. The backend server may analyze and process data sequences acquired by the terminal devices 101, 102, and 103, and feed back the processing results (for example, the data sequences after the denoising processing) to the terminal device.

It should be noted that the method for processing a data sequence provided by the embodiments of the present disclosure is generally executed by the server 105. Accordingly, the apparatus for processing a data sequence is generally provided in the server 105.

It should be noted that the server may be hardware or software. When the server is hardware, the server may be implemented as a distributed server cluster composed of a plurality of servers, or as a single server. When the server is software, the server may be implemented as a plurality of software or software modules (for example, for providing data sequence denoising services), or as a single software or software module, which is not specifically limited here.

It should be noted that the method for processing a data sequence provided by the embodiments of the present disclosure may also be executed by the terminal devices 101, 102, and 103. In this case, the exemplary system architecture 100 may not include the network 104 and the server 105, which is not limited in the present disclosure.

It should be appreciated that the numbers of the terminal devices, the networks and the servers in FIG. 1 are merely illustrative. Any number of terminal devices, networks and servers may be provided based on the implementation requirements.

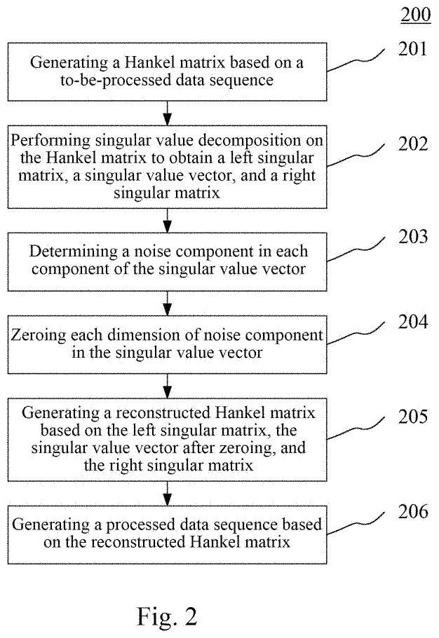

With further reference to FIG. 2, a flow 200 of an embodiment of a method for processing a data sequence. The method for processing a data sequence includes the following steps.

Step 201, generating a Hankel matrix based on a to-be-processed data sequence.

In the present embodiment, an executing body (e.g., the server shown in FIG. 1) of the method for processing a data sequence may first acquire a to-be-processed data sequence, the to-be-processed data sequence including zigzag noise, and then various implementations may be used to generate a Hankel matrix based on the to-be-processed data sequence.

Here, the to-be-processed data sequence may be stored locally in the executing body, and the executing body may locally acquire the to-be-processed data sequence.

Here, the to-be-processed data sequence may also be sent to the executing body by other electronic devices (for example, the terminal devices shown in FIG. 1) connected to the executing body via a network through a wired connection or a wireless connection, and the executing body may remotely acquire the to-be-processed data sequence from the other electronic devices.

Here, the to-be-processed data sequence is a data sequence in which at least one data is arranged in chronological order. Moreover, the to-be-processed data sequence includes zigzag noise. Here, the zigzag noise refers to noise added to the original data sequence including both of noise caused by adding a certain value to the original data and noise caused by subtracting a certain value from the original data.

In the present embodiment, the Hankel matrix refers to a matrix in which the elements on each counter-diagonal are equal. Here, the Hankel matrix may be a square matrix or not a square matrix.

As an example, the to-be-processed data sequence may be expressed as: X=[x₁, x₂, . . . , x_{N}], where N is a positive integer, and the to-be-processed data sequence X includes N sequentially arranged data [x₁, x₂, . . . , x_{N}].

In some alternative implementations of the present embodiment, the generating the Hankel matrix H based on the to-be-processed data sequence X=[x₁, x₂, . . . , x_{N}] may be performed as follows.

First, the number of rows R and the number of columns C of the Hankel matrix are determined based on the number N of data included in the to-be-processed data sequence X=[x₁, x₂, . . . , x_{N}], where the sum of R and C is equal to N plus one, that is, R+C=N+1. Then, the Hankel matrix H is obtained by calculation according to the following formula:

H(i,j)=xᵢ₊ⱼ₋₁

Here, i is an integer between 1 and R, and j is an integer between 1 and C.

In practice, in order to achieve better results in singular value decomposition, R and C may be approached as close as possible, so that the Hankel matrix His as close as possible to the square matrix. As an example, some specific examples are given below.

If N is an odd number, the matrix H includes R rows and C columns, where R=C=(N+1)/2, and H(i,j)=xⱼ₊ⱼ₋₁. For example, if N=5, then H is as follows:

$$H = [ \begin{matrix}{x}_{1} & {x}_{2} & {x}_{3} \\ {x}_{2} & {x}_{3} & {x}_{4} \\ {x}_{3} & {x}_{4} & {x}_{5}\end{matrix} ]$$

If N is an even number, the matrix H includes R rows and C columns, where R=N/2, C=(N/2)+1, and H(i,j)=xᵢ₊ⱼ₋₁. For example, if N=4, then H is as follows:

$$H = [ \begin{matrix}{x}_{1} & {x}_{2} & {x}_{3} \\ {x}_{2} & {x}_{3} & {x}_{4}\end{matrix} ]$$

Or, if N is an even number, the matrix H includes R rows and C columns, where R=(N/2)+1, C=N/2, and H(i,j)=xᵢ₊ⱼ₋₁. For example, if N=4, then H is as follows:

$$H = [ \begin{matrix}{x}_{1} & {x}_{2} \\ {x}_{2} & {x}_{3} \\ {x}_{3} & {x}_{4}\end{matrix} ]$$

In some alternative implementations of the present embodiment, the generating the Hankel matrix H based on the to-be-processed data sequence X=[x₁, x₂, . . . , x_{N}] may also be performed as follows.

The Hankel matrix H includes N rows and N columns, and the Hankel matrix H is obtained by calculation according to the following formula:

H(i,j)=xᵢ₊ⱼ₋₁,(i+j)≤N

H(i,j)=x₂ₙ₊₁₋ᵢ₋ⱼ(i+j)>N

Here i and j are integers between 1 and N. For example, if N=3, then H is as follows:

$$H = [ \begin{matrix}{x}_{1} & {x}_{2} & {x}_{3} \\ {x}_{2} & {x}_{3} & {x}_{2} \\ {x}_{3} & {x}_{2} & {x}_{3}\end{matrix} ]$$

Step 202, performing singular value decomposition on the Hankel matrix to obtain a left singular matrix, a singular value vector, and a right singular matrix.

In the present embodiment, the executing body (e.g., the server shown in FIG. 1) may perform singular value decomposition on the Hankel matrix obtained in step 201 to obtain a left singular matrix, a singular value vector, and a right singular matrix. Components of each dimension of the singular value vector are ordered from large to small. Specifically, the Hankel matrix H may be a matrix of R rows and C columns, and then the singular value decomposition of the Hankel matrix H may be performed by decomposing the Hankel matrix H into the following form:

H=UΣV^{T}

Here, U is the left singular matrix obtained by singular value decomposition of the Hankel matrix H, U is the matrix R×R; V is the right singular matrix obtained by singular value decomposition of the Hankel matrix H, V is the matrix C×C; Σ is a positive semidefinite R×C order diagonal matrix, each element σᵢ on the diagonal in the upper left corner square of Σ constitutes each component of the singular value vector E={σ₁, σ₂, . . . , σ_{M}} obtained by performing singular value decomposition on the Hankel matrix H.

Step 203, determining a noise component in each component of the singular value vector.

The singular values σᵢ of the singular value vector={σ₁, σ₂, . . . , σ_{M}} obtained in step 202 represent the weights of R rows of feature vectors composed of each row of elements in the left singular matrix U and C rows of feature vectors corresponding to each row of elements in the right singular matrix V to the to-be-processed sequence. In order to remove the noise in the to-be-processed sequence data sequence, the executing body of the method for processing a data sequence may determine the noise component in each component of the singular value vector based on the singular value vector obtained in step 202 and a preset noise suppression ratio threshold by adopting various implementations. The corresponding row of feature vectors in the left singular matrix U and the corresponding row of feature vectors in the right singular matrix V corresponding to the determined noise components may be regarded as noise feature vectors. To this end, the elements corresponding to the noise components in the singular value vector may be zeroed in a subsequent step 204, and the purpose of noise removal is achieved.

In some alternative implementations of the present embodiment, since the components of each dimension of the singular value vector are ordered from large to small, that is, component value of the first dimension of the singular value vector is the greatest, and the component value of the last dimension of the singular value vector is the smallest, the executing body may determine components from a preset number of dimension to the last dimension in the singular value vector as the noise components. Here, the preset number may be a positive integer preset by a technician according to experience, for example, the preset number may be 4, or the preset number may also be 6.

In some alternative implementations of the present embodiment, step 203 may also be performed as follows.

First, the positive integer w is set to 1, and the singular value vector is E={σ₁, σ₂, . . . , σ_{M}}, where M is a positive integer. In practice, M may be the smaller of the number of rows R and the number of columns C of the Hankel matrix H.

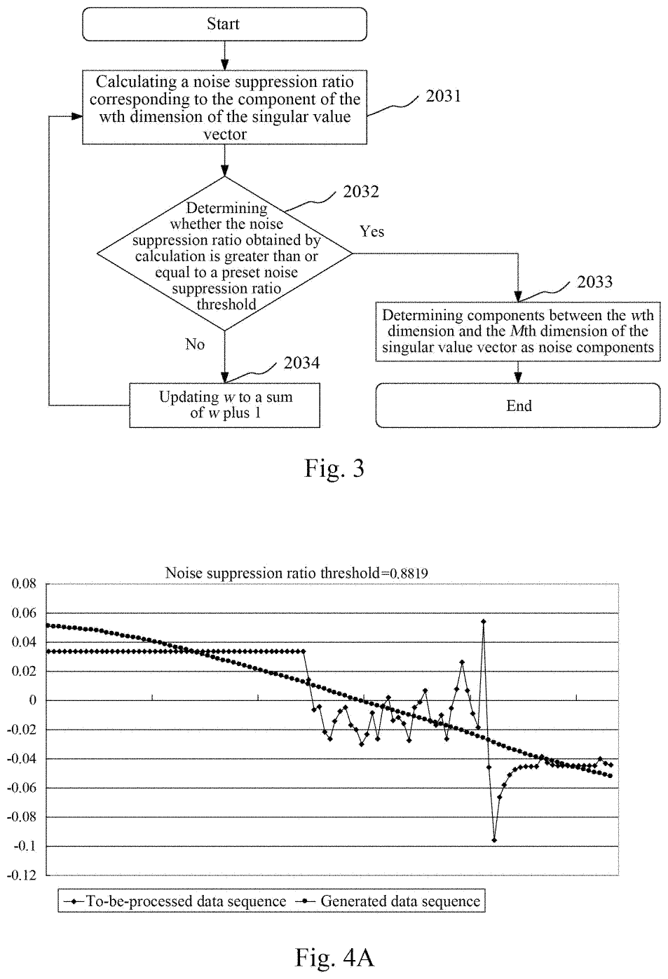

Then, a noise component determining operation is performed. Here, the noise component determining operation may include sub-step 2031 to sub-step 2033 as shown in FIG. 3.

In sub-step 2031, calculating a noise suppression ratio corresponding to the component of the w^{th} dimension of the singular value vector.

Specifically, the executing body may calculate the noise suppression ratio ρ_{w} of the component a of the w^{th} dimension of the singular value vector E={σ₁, σ₂, . . . , σ_{M}} according to the following formula:

$${ρ}_{w} \approx \frac{{\sum }_{i = 1}^{w} {σ}_{i}}{{\sum }_{i = 1}^{M} {σ}_{i}}$$

In sub-step 2032, determining whether the noise suppression ratio obtained by calculation is greater than or equal to a preset noise suppression ratio threshold.

If it is determined that the noise suppression ratio ρ_{w} obtained by calculation is greater than or equal to the preset noise suppression ratio threshold, then sub-step 2033 is performed, otherwise, sub-step 2034 is performed.

In sub-step 2033, determining components between the w^{th} dimension and the M^{th} dimension of the singular value vector as noise components, and ending the noise component determining operation.

Here, the executing body may determine components between the w^{th} dimension and the M^{th} dimension of the singular value vector as the noise components, and end the noise component determining operation, in the case where it is determined in sub-step 2032 that the noise suppression ratio ρ_{w} obtained by calculation is greater than or equal to the preset noise suppression ratio threshold.

The preset noise suppression ratio threshold is a numerical value greater than 0 and less than 1.

In sub-step 2034, updating w to a sum of w plus 1, and continuing performing the noise component determining operation.

Here, the executing body may update w to the sum of w plus 1, and proceed to sub-step 2031 to continue performing the noise component determining operation, in the case where the noise suppression ratio ρ_{w} obtained by calculation determined in sub-step 2032 is not greater than or equal to the preset noise suppression ratio threshold.

In some alternative implementations of the present embodiment, step 203 may also be performed as follows.

First, the singular value vector is set to be E={σ₁, σ₂, . . . , σ_{M}}, where M is a positive integer.

Then, a noise boundary dimension v may be found from the singular value vector, where a noise suppression ratio of the component of the v^{th} dimension among noise suppression ratios of the components of all dimensions of the singular value vector obtained by calculation calculated according to the following formula is closest to a preset noise suppression ratio threshold:

$${ρ}_{w} \approx \frac{{\sum }_{i = 1}^{w} {σ}_{i}}{{\sum }_{i = 1}^{M} {σ}_{i}}$$

Here, w is an integer between 1 and M.

Finally, components between the v^{th} dimension and the M^{th} dimension of the singular value vector are determined as noise components.

Step 204, zeroing each dimension of noise component in the singular value vector.

In the present embodiment, the executing body may zero each dimension of noise component in the singular value vector determined in step 203.

Step 205, generating a reconstructed Hankel matrix based on the left singular matrix, the singular value vector after zeroing, and the right singular matrix.

In the present embodiment, the executing body may generate a reconstructed Hankel matrix based on the left singular matrix obtained in step 202, the singular value vector after zeroing in step 204, and the right singular matrix obtained in step 202.

Specifically, it may be assumed that in step 202 the Hankel matrix H is singularly decomposed into the following form:

H=UτV^{T}

Here, U is the left singular matrix obtained by singular value decomposition of the Hankel matrix H, U is the matrix R×R; V is the right singular matrix obtained by singular value decomposition of the Hankel matrix H, V is the matrix C×C; Σ is a positive semidefinite R×C order diagonal matrix, and each element σᵢ on the diagonal in the upper left corner square of Σ constitutes each component of the singular value vector E={σ₁, σ₂, . . . , σ_{M}} obtained by performing singular value decomposition on the Hankel matrix H. The singular value vector after zeroing in step 204 may be expressed as E′, then generating the reconstructed Hankel matrix based on the left singular matrix, the singular value vector after zeroing, and the right singular matrix may be performed as follows.

First, take the values of the components of each dimension in E′ as the diagonal elements of the upper left corner square in the positive semidefinite R×C order diagonal matrix Σ′, and set the other elements in the matrix Σ′ to zero.

Then, calculate to obtain the reconstructed Hankel matrix H′ according to the following formula:

H′=UΣ′V^{T}

Step 206, generating a processed data sequence based on the reconstructed Hankel matrix.

Here, since the reconstructed Hankel matrix H′ after reconstruction in step 204 no longer has the characteristics of equal elements on the counter-diagonal of the Hankel matrix, further processing is required, and the processed data sequence X′ is generated. The Hankel matrix generated by the processed data sequence X′ according to the method in step 201 has the characteristics of the equal elements on the counter-diagonal of the Hankel matrix.

Specifically, the processed data sequence X′=[x₁′, x₂′, . . . , x_{N}′] may be generated based on the reconstructed Hankel matrix H′ according to the following formula:

$${x}_{k}^{′} = \frac{1}{n - m + 1} {\sum }_{j = m}^{n} {H}^{′} ( k - j + 1 , j ) , \\ m = max ( 1 , k - R + 1 ) , \\ n = min ( C , k )$$

Here, k is an integer between 1 and N.

As an example, suppose N=5, R=C=3, then H is as follows:

$$H = [ \begin{matrix}{x}_{1} & {x}_{2} & {x}_{3} \\ {x}_{2} & {x}_{3} & {x}_{4} \\ {x}_{3} & {x}_{4} & {x}_{5}\end{matrix} ]$$

After reconstructing the Hankel matrix H, the reconstructed Hankel matrix H′ is obtained, and the data sequence X′=[x₁′, x₂′, . . . , x_{N}′] is generated according to the above method, in which:

x₁′=H′(1,1)

x₂′=½(H′(2,1)+H′(2,1))

x₃′=⅓(H′(3,1)+H′(2,2)+H′(1,3))

x₄′=¼(H′(4,1)+H′(3,2)+H′(2,3)+H′(1,4))

x₅′=¼(H′(5,1)+H′(4,2)+H′(3,3)+H′(2,4)+H′(1,5))

It can be seen from the generated data sequence X′=[x₁′, x₂′, . . . , x_{N}′] that, suppose the Hankel matrix generated based on the generated data sequence X′=[x₁′, x₂′, . . . , x_{N}′] according to the method in step 201 is H″, then H′ has the characteristics of the equal elements on the counter-diagonal of the Hankel matrix. Moreover, the sum of the respective counter-diagonal elements of H″ is equal to the sum of the respective counter-diagonal elements of H′.

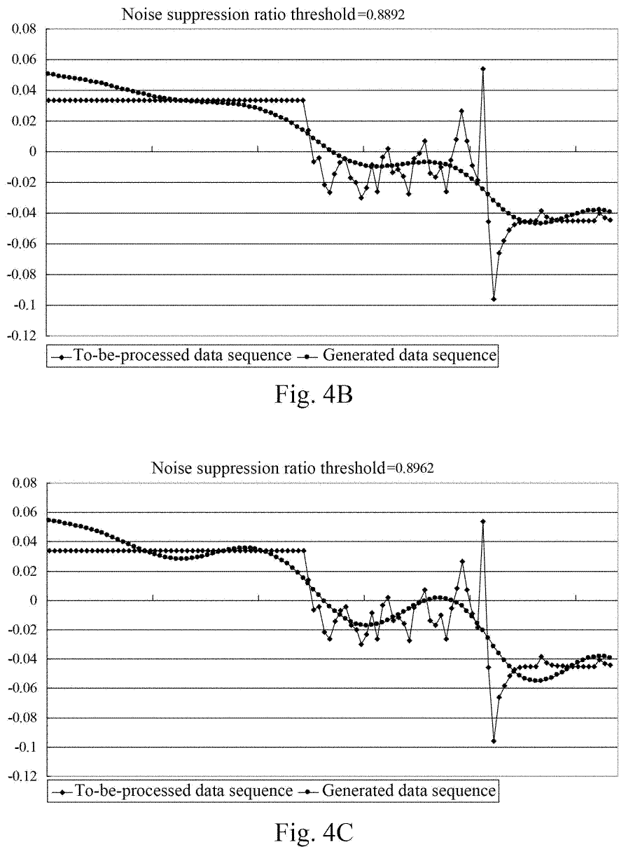

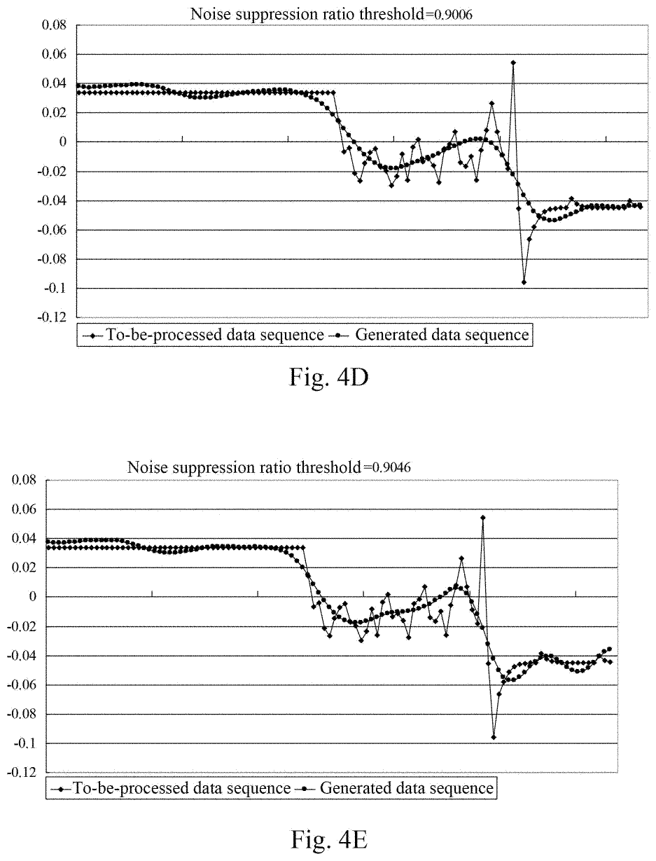

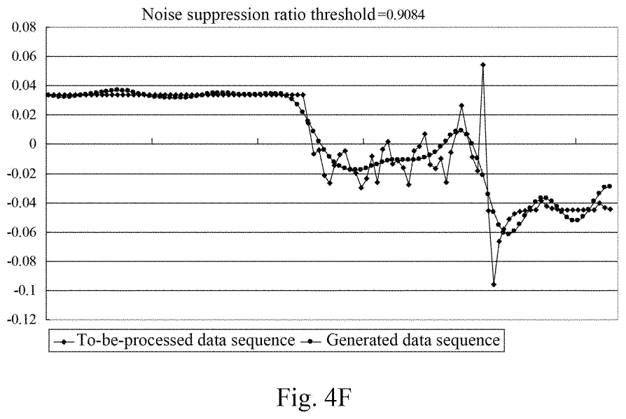

With further reference to FIGS. 4A-4F, FIGS. 4A-4F are schematic diagrams illustrating generated data sequences and an original to-be-processed data sequence, in which the data sequences are finally generated in step 204 for different noise suppression ratio thresholds in the process of determining the noise components in the singular value vector using the preset noise suppression ratio threshold control in step 203, based on the method for processing a data sequence according to the present embodiment shown in FIG. 2. As can be seen from FIGS. 4A-4F, the smaller the noise suppression ratio threshold is, the farther the generated data sequence is from the original to-be-processed data sequence, and the greater the noise suppression ratio threshold is, the closer the generated data sequence is to the original to-be-processed data sequence. In practice, if the noise suppression ratio threshold is too small, the generated data sequence is too far from the original to-be-processed sequence, that is, the original data in the original to-be-processed data sequence may be lost, and the data that is not noise is taken as noise. Conversely, if the noise suppression ratio threshold is too large, the generated data sequence is too close to the original to-be-processed sequence, which may result in non-removal of the to-be-removed noise. To this end, it is necessary to select a reasonable noise suppression ratio threshold according to practical experience to achieve a good denoising effect.

Some embodiments of the present disclosure generate a Hankel matrix based on a to-be-processed data sequence including zigzag noise, then performs singular value decomposition on the Hankel matrix to obtain a left singular matrix, a singular value vector, and a right singular matrix, components of each dimension of the singular value vector being ordered from large to small, determines a noise component in each component of the singular value vector based on the singular value vector and a preset noise suppression ratio threshold, zeros each dimension of noise component in the singular value vector, generates a reconstructed Hankel matrix based on the left singular matrix, the singular value vector after zeroing, and the right singular matrix, and finally generates a processed data sequence based on the reconstructed Hankel matrix. Therefore, a priori assumption is not performed on the data distribution of the acquired data source, but in the case that the to-be-processed data sequence includes zigzag noise, the singular value decomposition method is used to perform denoising processing on the to-be-processed data sequence, and the technical effects thereof may at least include the following aspects.

First, by denoising a data sequence including zigzag noise, it is no longer dependent on the assumption of a priori distribution of data acquired by the acquired data source.

Secondly, by using the singular value decomposition method, the distance between the data sequence obtained after the denoising processing and the to-be-processed data sequence is reduced.

Thirdly, in determining the noise components in the singular value vector, the effect of denoising is controlled by controlling the preset noise suppression ratio threshold in an alternative implementation.

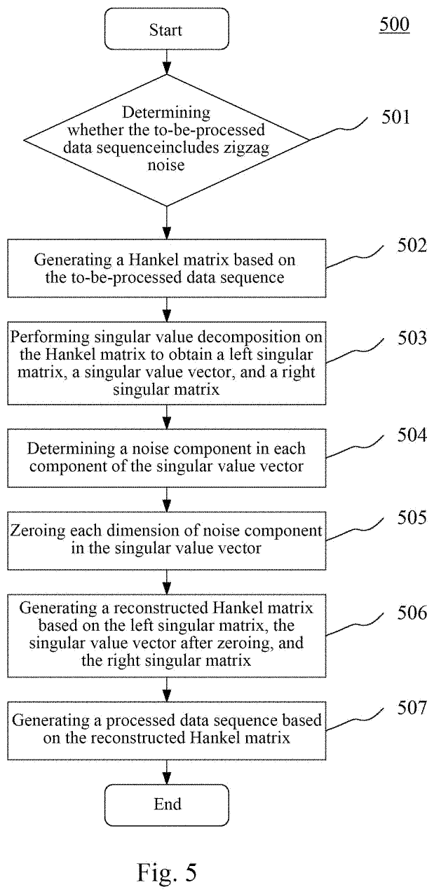

With further reference to FIG. 5, a flow 500 of another embodiment of the method for processing a data sequence is illustrated. The flow 500 of the method for processing a data sequence includes the following steps.

Step 501, determining whether the to-be-processed data sequence includes zigzag noise.

In the present embodiment, an executing body of the method for processing a data sequence (e.g., the server shown in FIG. 1) may use various implementations to determine whether the to-be-processed data sequence includes zigzag noise, proceed to step 502 if it is determined that the to-be-processed data sequence includes zigzag noise, and end the step if it is determined that zigzag noise is not included.

In some alternative implementations of the present embodiment, step 501 may be performed as follows.

First, for each data in the to-be-processed data sequence, determining K data, among the other data than the data in the to-be-processed data sequence, having the smallest absolute value of the difference from the data, and determining the maximum of the absolute values of the K differences between the determined K data and the data as the noise score corresponding to the data. Here, K may be a preset positive integer, for example, K may be 3 or 5, or the like.

Then, establishing an empty noise data set.

Next, for each data in the to-be-processed data sequence, determining whether the noise score corresponding to the data is greater than a predetermined noise score threshold, if the data is greater than the predetermined noise score threshold, adding the data to the noise data set. The noise score threshold may be a manually set value by a technician based on experience. For example, the absolute value of the difference between two adjacent data in the historical data sequence having the same state indicator represented by the to-be-processed data sequence may be counted. Then, a value having a confidence interval of 95% among the absolute values obtained by counting is determined as the predetermined noise score threshold.

Finally, determining whether a ratio of the number of noise data in the noise data set to the number of data in the to-be-processed data sequence is greater than a first preset ratio threshold. If the ratio of the number of noise data in the noise data set to the number of data in the to-be-processed data sequence is greater than the first preset ratio threshold, it may be determined that the to-be-processed data sequence includes zigzag noise, if the ratio of the number of noise data in the noise data set to the number of data in the to-be-processed data sequence is not greater than the first preset ratio threshold, it may be determined that the to-be-processed data sequence does not include zigzag noise. As an example, the first preset ratio threshold may be 10% or 25%, or the like.

In some alternative implementations of the present embodiment, step 501 may also be performed as follows.

First, for each data in the to-be-processed data sequence, determining K data, among the other data than the data in the to-be-processed data sequence, having the smallest absolute value of the difference from the data, and determining the maximum of the absolute values of the K differences between the determined K data and the data as the noise score corresponding to the data. Here, K may be a preset positive integer, for example, K may be 3 or 5, or the like.

Then, establishing an empty noise data set.

Next, for each data in the to-be-processed data sequence, determining whether a ratio of the number of noise data in the noise data set to the number of data in the to-be-processed data sequence is less than a second preset ratio threshold. If it is determined to be less, the data is added to the noise data set; if it is determined to be not less, it is determined whether the noise score corresponding to the data is greater than or equal to the noise score corresponding to each noise data in the noise data set, and if it is determined to be greater, the data is added to the noise data set.

Finally, determining whether a ratio of the number of noise data in the noise data set to the number of data in the to-be-processed data sequence is greater than a third preset ratio threshold. If the noise data set to the number of data in the to-be-processed data sequence is greater than the third preset ratio threshold, it may be determined that the to-be-processed data sequence includes zigzag noise, if the noise data set to the number of data in the to-be-processed data sequence is not greater than the third preset ratio threshold, it may be determined that the to-be-processed data sequence does not include zigzag noise. The second preset ratio threshold is less than the third ratio threshold.

Step 502, generating a Hankel matrix based on the to-be-processed data sequence.

In the present embodiment, the executing body may generate a Hankel matrix based on the to-be-processed data sequence in the case where it is determined in step 501 that the to-be-processed data sequence includes zigzag noise.

Step 503, performing singular value decomposition on the Hankel matrix to obtain a left singular matrix, a singular value vector, and a right singular matrix.

Step 504, determining a noise component in each component of the singular value vector.

Step 505, zeroing each dimension of noise component in the singular value vector.

Step 506, generating a reconstructed Hankel matrix based on the left singular matrix, the singular value vector after zeroing, and the right singular matrix.

Step 507, generating a processed data sequence based on the reconstructed Hankel matrix.

The specific operations of the steps 502-507 in the present embodiment are substantially the same as the operations of the steps 201-206 in the embodiment shown in FIG. 2, and detailed descriptions thereof will be omitted.

As can be seen from FIG. 5, the flow 500 of the method for processing a data sequence in the present embodiment has the step of determining whether the to-be-processed data sequence includes zigzag noise as compared with the embodiment corresponding to FIG. 2. Therefore, the solution described in the present embodiment may implement denoising processing on the to-be-processed data sequence in the case that the to-be-processed data sequence includes zigzag noise, and does not perform any processing on the to-be-processed data sequence in the case that the to-be-processed data sequence does not include zigzag noise, thereby achieving a more comprehensive data sequence processing.

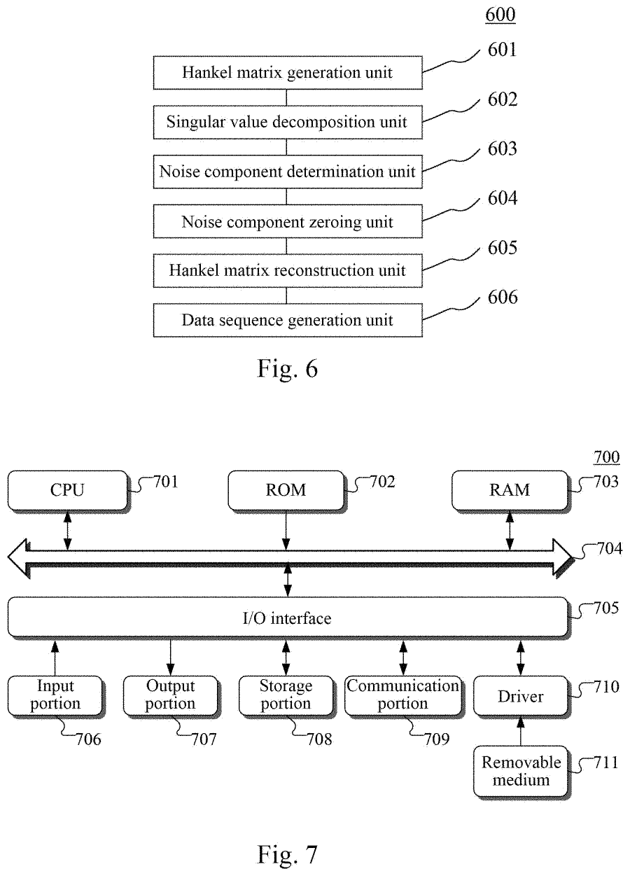

With further reference to FIG. 6, as an implementation of the method shown in the above figures, disclosed is an embodiment of an apparatus for processing a data sequence, and the apparatus embodiment corresponds to the method embodiment as shown in FIG. 2, and the apparatus may be specifically applied to various electronic devices.

As shown in FIG. 6, the apparatus 600 for processing a data sequence of the present embodiment includes: a Hankel matrix generation unit 601, a singular value decomposition unit 602, a noise component determination unit 603, a noise component zeroing unit 604, a Hankel matrix reconstruction unit 605 and a data sequence generation unit 606. Here, the Hankel matrix generation unit 601 is configured to generate a Hankel matrix based on a to-be-processed data sequence, the to-be-processed data sequence including zigzag noise; the singular value decomposition unit 602 is configured to perform singular value decomposition on the Hankel matrix to obtain a left singular matrix, a singular value vector, and a right singular matrix, components of each dimension of the singular value vector being ordered from large to small; the noise component determination unit 603 is configured to determine a noise component in each component of the singular value vector; the noise component zeroing unit 604 is configured to zero each dimension of noise component in the singular value vector; the Hankel matrix reconstruction unit 605 is configured to generate a reconstructed Hankel matrix based on the left singular matrix, the singular value vector after zeroing, and the right singular matrix; and the data sequence generation unit 606 is configured to generate a processed data sequence based on the reconstructed Hankel matrix.

In the present embodiment, the specific processing and the technical effects of the Hankel matrix generation unit 601, the singular value decomposition unit 602, the noise component determination unit 603, the noise component zeroing unit 604, the Hankel matrix reconstruction unit 605 and the data sequence generation unit 606 may be referred to in the related descriptions of step 201, step 202, step 203, step 204, step 205 and step 206 in the corresponding embodiment of FIG. 2, respectively, and detailed decryptions thereof will be omitted.

In some alternative implementations of the present embodiment, the Hankel matrix generation unit may include: a zigzag noise determination unit (not shown in FIG. 6), configured to determine whether the to-be-processed data sequence includes zigzag noise; and a Hankel matrix generation module (not shown in FIG. 6), configured to generate, in response to determining that the to-be-processed data sequence includes zigzag noise, the Hankel matrix based on the to-be-processed data sequence.

In some alternative implementations of the present embodiment, the to-be-processed data sequence may include N data; and the Hankel matrix generation module (not shown in FIG. 6) may be further configured to: determine, according to N, a number of rows Rand a number of columns C of the Hankel matrix, where a sum of R and C is equal to a sum of N plus 1; and set the to-be-processed data sequence to be: X=[x₁, x₂, . . . , x_{N}], and calculate to obtain the Hankel matrix H according to the following formula:

H(i,j)=xⱼ₊ⱼ₋₁

Here, i is an integer between 1 and R, and j is an integer between 1 and C.

In some alternative implementations of the present embodiment, the data sequence generation unit 606 may be further configured to: set the reconstructed Hankel matrix to be H′, and generate the processed data sequence X′=[x₁′, x₂′, . . . , x_{N}′] based on the reconstructed Hankel matrix H′ according to the following formula:

$${x}_{k}^{′} = \frac{1}{n - m + 1} {\sum }_{j = m}^{n} {H}^{′} ( k - j + 1 , j ) , \\ m = max ( 1 , k - R + 1 ) , \\ n = min ( C , k )$$

Here, k is an integer between 1 and N.

In some alternative implementations of the present embodiment, the noise component zeroing unit 603 may be further configured to: set a positive integer w to 1, the singular value vector being E={σ₁, σ₂, . . . , σ_{M}}, where M is a positive integer; perform a following noise component determining operation: calculating a noise suppression ratio ρ_{w} corresponding to the component of the w^{th} dimension of the singular value vector according to the following formula:

$${ρ}_{w} \approx \frac{{\sum }_{i = 1}^{w} {σ}_{i}}{{\sum }_{i = 1}^{M} {σ}_{i}}$$

determining, in response to determining that the noise suppression ratio ρ_{w} obtained by calculation is greater than or equal to a preset noise suppression ratio threshold, components between the w^{th} dimension and the M^{th} dimension of the singular value vector as noise components, and ending the noise component determining operation, where the preset noise suppression ratio threshold is a value greater than 0 and less than 1; and update, in response to determining that the noise suppression ratio ρ_{w} obtained by calculation is not greater than or equal to the preset noise suppression ratio threshold, w to a sum of w plus 1, and continue performing the noise component determining operation.

In some alternative implementations of the present embodiment, the noise component zeroing unit 603 may be further configured to: set the singular value vector to be E={σ₁, σ₂, . . . , σ_{M}}, where M is a positive integer; find a noise boundary dimension v from the singular value vector, where a noise suppression ratio of the component of the v^{th} dimension among noise suppression ratios of components of all dimensions of the singular value vector obtained by calculation calculated according to the following formula is closest to a preset noise suppression ratio threshold:

$${ρ}_{w} \approx \frac{{\sum }_{i = 1}^{w} {σ}_{i}}{{\sum }_{i = 1}^{M} {σ}_{i}} ;$$

where, w is an integer between 1 and M; and determine components between the v^{th} dimension and the M^{th} dimension of the singular value vector as noise components.

It should be noted that the implementation details and technical effects of the units in the apparatus for processing a data sequence provided by the embodiments of the present disclosure may be referred to in the description of other embodiments in the present disclosure, and detailed decryptions thereof will be omitted.

With further reference to FIG. 7, a schematic structural diagram of a computer system 700 adapted to implement an electronic device of the embodiments of the present disclosure is shown. The electronic device shown in FIG. 7 is merely an example, and should not impose any limitation on the function and scope of use of the embodiments of the present disclosure.

As shown in FIG. 7, the computer system 700 includes a central processing unit (CPU) 701, which may execute various appropriate actions and processes in accordance with a program stored in a read-only memory (ROM) 702 or a program loaded into a random access memory (RAM) 703 from a storage portion 708. The RAM 703 also stores various programs and data required by operations of the system 700. The CPU 701, the ROM 702 and the RAM 703 are connected to each other through a bus 704. An input/output (I/O) interface 705 is also connected to the bus 704.

The following components are connected to the I/O interface 705: an input portion 706 including a keyboard, a mouse, etc.; an output portion 707 including such as a cathode ray tube (CRT), a liquid crystal display device (LCD), a speaker, etc.; a storage portion 708 including a hard disk or the like; and a communication portion 709 including a network interface card, such as a LAN (Local Area Network) card and a modem. The communication portion 709 performs communication processes via a network, such as the Internet. A driver 710 is also connected to the I/O interface 705 as required. A removable medium 711, such as a magnetic disk, an optical disk, a magneto-optical disk, and a semiconductor memory, may be installed on the driver 710, to facilitate the retrieval of a computer program from the removable medium 711, and the installation thereof on the storage portion 708 as needed.

In particular, according to the embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for performing the method as illustrated in the flow chart. In such an embodiment, the computer program may be downloaded and installed from a network via the communication portion 709, and/or may be installed from the removable medium 711. The computer program, when executed by the central processing unit (CPU) 701, implements the above mentioned functionalities as defined by the method of some embodiments of the present disclosure. It should be noted that the computer readable medium in some embodiments of the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In some embodiments of the present disclosure, the computer readable storage medium may be any physical medium containing or storing programs which may be used by a command execution system, apparatus or element or incorporated thereto. In some embodiments of the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

A computer program code for performing operations in some embodiments of the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the accompanying drawings. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system performing specified functions or operations, or by a combination of a dedicated hardware and computer instructions.

The units involved in the embodiments of the present disclosure may be implemented by means of software or hardware. The described units may also be provided in a processor, for example, may be described as: a processor, including a Hankel matrix generation unit, a singular value decomposition unit, a noise component determination unit, a noise component zeroing unit, a Hankel matrix reconstruction unit and a data sequence generation unit. Here, the names of these units do not in some cases constitute limitations to such units themselves. For example, the Hankel matrix generation unit may also be described as “a unit for generating a Hankel matrix based on a to-be-processed data sequence.”

In another aspect, embodiments of the present disclosure further provide a computer readable medium. The computer readable medium may be included in the apparatus in the above described embodiments, or a stand-alone computer readable medium not assembled into the apparatus. The computer readable medium stores one or more programs. The one or more programs, when executed by the apparatus, cause the apparatus to: generate a Hankel matrix based on a to-be-processed data sequence, the to-be-processed data sequence including zigzag noise; perform singular value decomposition on the Hankel matrix to obtain a left singular matrix, a singular value vector, and a right singular matrix, components of each dimension of the singular value vector being ordered from large to small; determine a noise component in each component of the singular value vector; zero each dimension of noise component in the singular value vector; generate a reconstructed Hankel matrix based on the left singular matrix, the singular value vector after zeroing, and the right singular matrix; and generate a processed data sequence based on the reconstructed Hankel matrix.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

What is claimed is:

1. A method for processing a data sequence, the method comprising:
generating a Hankel matrix based on a to-be-processed data sequence, the to-be-processed data sequence comprising zigzag noise;
performing singular value decomposition on the Hankel matrix to obtain a left singular matrix, a singular value vector, and a right singular matrix, components of each dimension of the singular value vector being ordered from large to small;
determining a noise component in each component of the singular value vector;
zeroing each dimension of noise component in the singular value vector;
generating a reconstructed Hankel matrix based on the left singular matrix, the singular value vector after zeroing, and the right singular matrix; and
generating a processed data sequence based on the reconstructed Hankel matrix.

2. The method according to claim 1, wherein the generating a Hankel matrix based on a to-be-processed data sequence, comprises:
determining whether the to-be-processed data sequence comprises zigzag noise; and
generating, in response to determining that the to-be-processed data sequence comprises zigzag noise, the Hankel matrix based on the to-be-processed data sequence.

3. The method according to claim 2, wherein the to-be-processed data sequence comprises N data; and
the generating the Hankel matrix based on the to-be-processed data sequence, comprises:
determining, according to N, a number of rows R and a number of columns C of the Hankel matrix, wherein a sum of R and C is equal to a sum of N plus 1; and
setting the to-be-processed data sequence to be: X=[x₁, x₂, . . . , x_{N}], and calculating to obtain the Hankel matrix H according to a following formula:
H(i,j)=xᵢ₊ⱼ₋₁
wherein, i is an integer between 1 and R, and j is an integer between 1 and C.

4. The method according to claim 3, wherein the generating a processed data sequence based on the reconstructed Hankel matrix, comprises:
setting the reconstructed Hankel matrix to be H′, and generating the processed data sequence X′=[x₁′, x₂′, . . . , x_{N}′] based on the reconstructed Hankel matrix H′ according to a following formula:
$${x}_{k}^{′} = \frac{1}{n - m + 1} {\sum }_{j = m}^{n} {H}^{′} ( k - j + 1 , j ) , \\ m = max ( 1 , k - R + 1 ) , \\ n = min ( C , k )$$
wherein, k is an integer between 1 and N.

5. The method according to claim 4, wherein the determining a noise component in each component of the singular value vector, comprises:
setting a positive integer w to 1, the singular value vector being E={σ₁, σ₂, . . . , σ_{M}}, wherein M is a positive integer;
performing a following noise component determining operation: calculating a noise suppression ratio ρ_{w} corresponding to a component of a w^{th} dimension of the singular value vector according to a following formula:
$${ρ}_{w} \approx \frac{{\sum }_{i = 1}^{w} {σ}_{i}}{{\sum }_{i = 1}^{M} {σ}_{i}}$$
determining, in response to determining that the noise suppression ratio ρ_{w} obtained by calculation is greater than or equal to a preset noise suppression ratio threshold, components between the w^{th} dimension and an M^{th} dimension of the singular value vector as noise components, and ending the noise component determining operation, wherein the preset noise suppression ratio threshold is a value greater than 0 and less than 1; and updating, in response to determining that the noise suppression ratio ρ_{w} obtained by calculation is not greater than or equal to the preset noise suppression ratio threshold, w to a sum of w plus 1, and continuing performing the noise component determining operation.

6. The method according to claim 4, wherein the determining a noise component in each component of the singular value vector, comprises:
setting the singular value vector to be E={σ₁, σ₂, . . . , σ_{M}}, wherein M is a positive integer;
finding a noise boundary dimension v from the singular value vector, wherein a noise suppression ratio of a component of a v^{th} dimension among noise suppression ratios of components of all dimensions of the singular value vector obtained by calculation calculated according to a following formula is closest to a preset noise suppression ratio threshold:
$${ρ}_{w} \approx \frac{{\sum }_{i = 1}^{w} {σ}_{i}}{{\sum }_{i = 1}^{M} {σ}_{i}}$$
wherein, w is an integer between 1 and M; and
determining components between the v^{th} dimension and an M^{th} dimension of the singular value vector as noise components.

7. An apparatus for processing a data sequence, the apparatus comprising:
at least one processor; and
a memory storing instructions, the instructions when executed by the at least one processor, cause the at least one processor to perform operations, the operations comprising:
generating a Hankel matrix based on a to-be-processed data sequence, the to-be-processed data sequence comprising zigzag noise;
performing singular value decomposition on the Hankel matrix to obtain a left singular matrix, a singular value vector, and a right singular matrix, components of each dimension of the singular value vector being ordered from large to small;
determining a noise component in each component of the singular value vector;
zeroing each dimension of noise component in the singular value vector;
generating a reconstructed Hankel matrix based on the left singular matrix, the singular value vector after zeroing, and the right singular matrix; and
generating a processed data sequence based on the reconstructed Hankel matrix.

8. The apparatus according to claim 7, wherein the generating a Hankel matrix based on a to-be-processed data sequence, comprises:
determining whether the to-be-processed data sequence comprises zigzag noise; and
generating, in response to determining that the to-be-processed data sequence comprises zigzag noise, the Hankel matrix based on the to-be-processed data sequence.

9. The apparatus according to claim 8, wherein the to-be-processed data sequence comprises N data; and
the generating the Hankel matrix based on the to-be-processed data sequence, comprises:
determining, according to N, a number of rows R and a number of columns C of the Hankel matrix, wherein a sum of R and C is equal to a sum of N plus 1; and
setting the to-be-processed data sequence to be: X=[x₁, x₂, . . . , x_{N}], and calculate to obtain the Hankel matrix H according to a following formula:
H(i,j)=xᵢ₊ⱼ₋₁
wherein, i is an integer between 1 and R, and j is an integer between 1 and C.

10. The apparatus according to claim 9, wherein the generating a processed data sequence based on the reconstructed Hankel matrix, comprises:
setting the reconstructed Hankel matrix to be H′, and generate the processed data sequence X′=[x₁′, x₂′, . . . , x_{N}′] based on the reconstructed Hankel matrix H′ according to a following formula:
$${x}_{k}^{′} = \frac{1}{n - m + 1} {\sum }_{j = m}^{n} {H}^{′} ( k - j + 1 , j ) , \\ m = max ( 1 , k - R + 1 ) , \\ n = min ( C , k )$$
wherein, k is an integer between 1 and N.

11. The apparatus according to claim 10, wherein the determining a noise component in each component of the singular value vector, comprises:
setting a positive integer w to 1, the singular value vector being E={σ₁, σ₂, . . . , σ_{M}}, wherein M is a positive integer;
performing a following noise component determining operation: calculating a noise suppression ratio ρ_{w} corresponding to a component of a w^{th} dimension of the singular value vector according to a following formula:
$${ρ}_{w} \approx \frac{{\sum }_{i = 1}^{w} {σ}_{i}}{{\sum }_{i = 1}^{M} {σ}_{i}}$$
determining, in response to determining that the noise suppression ratio ρ_{w} obtained by calculation is greater than or equal to a preset noise suppression ratio threshold, components between the w^{th} dimension and an M^{th} dimension of the singular value vector as noise components, and ending the noise component determining operation, wherein the preset noise suppression ratio threshold is a value greater than 0 and less than 1; and updating, in response to determining that the noise suppression ratio ρ_{w} obtained by calculation is not greater than or equal to the preset noise suppression ratio threshold, w to a sum of w plus 1, and continuing performing the noise component determining operation.

12. The apparatus according to claim 10, wherein the determining a noise component in each component of the singular value vector, comprises:
setting the singular value vector to be E={σ₁, σ₂, . . . , σ_{M}}, wherein M is a positive integer;
finding a noise boundary dimension v from the singular value vector, wherein a noise suppression ratio of a component of a v^{th} dimension among noise suppression ratios of components of all dimensions of the singular value vector obtained by calculation calculated according to a following formula is closest to a preset noise suppression ratio threshold:
$${ρ}_{w} \approx \frac{{\sum }_{i = 1}^{w} {σ}_{i}}{{\sum }_{i = 1}^{M} {σ}_{i}}$$
wherein, w is an integer between 1 and M; and
determining components between the v^{th} dimension and an M^{th} dimension of the singular value vector as noise components.

13. A non-transitory computer readable storage medium, storing a computer program thereon, the computer program, when executed by a processor, causes the processor to perform operations, the operations comprising:
generating a Hankel matrix based on a to-be-processed data sequence, the to-be-processed data sequence comprising zigzag noise;
performing singular value decomposition on the Hankel matrix to obtain a left singular matrix, a singular value vector, and a right singular matrix, components of each dimension of the singular value vector being ordered from large to small;
determining a noise component in each component of the singular value vector;
zeroing each dimension of noise component in the singular value vector;
generating a reconstructed Hankel matrix based on the left singular matrix, the singular value vector after zeroing, and the right singular matrix; and
generating a processed data sequence based on the reconstructed Hankel matrix.
